(19) United States
(12) Patent Application Publication
(10) Pub. No.: US 2005/0186871 A1
(43) Pub. Date: Aug. 25, 2005

(54) Photocatalysts, electrets, and hydrophobic surfaces used to filter, clean, disinfect, and deodorize

(75) Inventor: Robert G. Hockaday, Los Alamos, NM (US)

Correspondence Address: JAMES C. WRAY, 1493 CHAIN BRIDGE ROAD, SUITE 300, MCLEAN, VA, 22101, US

(73) Assignee: Energy Related Devices, Inc.

(21) Appl. No.: 11/064,961

(22) Filed: Feb. 25, 2005

Related U.S. Application Data
(60) Provisional application No. 60/547,073, filed on Feb. 25, 2004.

(51) Int. Cl. B32B 5/22; B32B 5/18

(52) U.S. Cl. 442/76

(57) ABSTRACT

Photocatalysts, electrets, and hydrophobic surfaces are geometrically integrated to achieve a self-cleaning air filter, fabric, or surface. This can be incorporated into surfaces and apparel to wick, disinfect, deodorize, and clean their surfaces with the action of the photocatalyst, water, and light on absorbed chemicals, bacteria, funguses, viruses, and particulates. The photocatalysts can be electrically connected to achieve electro-osmotic control and electrical energy output. This leads to protection from chemicals, bacteria, funguses, viruses, and greater humidity control and comfort in apparel, structures, air cleaners, and in particular, eyewear.

This application claims the benefit of U.S. Provisional Application No. 60/547,073, filed Feb. 25, 2004.

### BACKGROUND OF THE INVENTION

In apparel there is a need to deodorize, disinfect, and ventilate. Apparel such as eyewear, shoes, socks, gloves, jackets, and hats. The human body emits dead skin, oils, bacteria, viruses, blood, sweat, and moisture. Typically, apparel needs to be able to remove the moisture, thermally insulate the user, and shield the user from contaminants and light. From the surrounding environment apparel comes in contact with a wide host of contaminants such as oils, ammonia, hydrocarbon, aromatic hydrocarbons, water, salts, dirt, bacteria, viruses, and funguses. The warm moist conditions of the human in apparel such as face gaskets of goggles on a human head in the air intakes and outlet vents, and the head strap, can be ideal areas for sustenance and growth of bacteria, fungus colonies, and preservation of viruses. The residence and growth of bacteria and fungus colonies can lead to generation of odors in the apparel. The presence of the bacteria, funguses, and viruses can lead to the spreading of infections over the wearer's body and can lead to transmission of infections in contact with other people or animals.

It has been found that photocatalysts such as titanium dioxide can break down and oxidize organic compounds that become absorbed on the surface of the photocatalysts with the blue light photons above 3.2 eV in energy, and in the presence of oxygen and water. These photocatalysts also destroy bacteria, funguses, and viruses that are in contact with the photocatalyst. The photocatalyst reaction and effectiveness is greatly increased if water is present on the surface of the photocatalyst. Relative humidities above 40% are needed for titanium dioxide to achieve this enhancement. The chemical reactivity of the photocatalytic surfaces makes them very hydrophilic. By combining the photocatalysts with apparel that is frequently exposed to sunlight or blue light, a range of self-cleaning and disinfecting properties can be achieved.

The traditional methods of deodorizing and disinfecting surfaces of apparel are high temperature pasteurization, soap and water washes, immersion in reactive chemicals such as salts, chlorine, or ozone, impregnation and slow emission of biocides such as formaldehyde, irradiation with electrons, or charged particles, x-rays, and UV light.

Heating the apparel to sterilization temperatures can destroy the product by melting plastic components, or causing the materials to flow, slump, or vaporize.

Incorporation of these disinfecting techniques such as biocides in clothing can lead to the clothing emitting irritating odors, hazardous to the user, and skin irritation. Leaving an odor from chemicals absorbed in the apparel can also make the apparel more detectable by animals and humans, which is particularly important in warfare and hunting.

Periodic cleaning is typically done with many apparel products, but it can be inconvenient and an expenditure of excess energy. The washing also interrupts the use of the apparel and can damage its performance by modifying the adhesion or leaving solvents inside the apparel. Hydrophobic or hydrophilic surface properties which are important for water removal can be lost with soap washing. The properties of thermal and electrical insulation can be degraded if water is left in or on their surfaces. The washing process can damage bonding materials such as glues by coating the glues with films and dissolving necessary chemical components.

Some components such as antifogging coatings are typically water absorbing such that if they are left to soak in water for a long period of time can soften and easily lose adhesion to the lens surfaces. The double lenses in goggles contain air spaces and can be filled with water and chemicals with immersion cleaning. This destroys the transparency and insulation properties of the double lenses. If devices such as electronics, batteries, and fuel cells are incorporated into apparel, coating them with water with reactive chemicals can destroy or degrade their performance typically by shorting the circuitry, thus washing is impractical.

Incorporation of continuous irradiation or periodic irradiation can be heavy, inconvenient, expensive, and possibly hazardous to the user. The materials such as plastics and rubber can decompose under energetic radiation. The function of the apparel is often to shield the user from ultraviolet light and radiation, thus the interior surfaces of the apparel are protected from the typical sterilization of ultraviolet light, enhancing the suitability for bacteria and fungus growth.

The conditions of high humidity, warmth, and body contact in eyewear make them ideal for maintaining and supporting, bacteria, funguses, and viruses. Odors that are absorbed into the eyewear are more noticeable because they are in close proximity to the nose of the user. The close contact of the eyewear with the body and near the eyes, nose, and mouth make them well situated to spread or maintain infections and irritate the user.

The traditional method of disinfecting these surfaces is to immerse them in chemical washes such as chlorinated water, sodium hypochlorite (bleach), soap, and/or water. This can lead to irritating chemicals left on the apparel, decomposition of the apparel, or simply leaving the apparel wet from the rinse water.

Photocatalysts have been known for their properties to deodorize and disinfect for some time. Their properties of wetting and water interaction are also documented. An additional effect of a photocatalyst is the surface free energy is high after creating active chemicals on the surface of the photocatalyst leading to high adhesion (high surface free energy). Photocatalytic surfaces would be expected to be hydrophilic. Water adhesion gradients have also been utilized to demonstrate the manipulation of water on surfaces and can be used to move liquid water beyond simply capillary action of wicks.

The properties of forming high surface area surfaces to enhance the water adhesion effects have been utilized in materials such as shaping polyester fibers to provide water wicking channels in products such as Cool Max® (DuPont Corp., 1007 Market Street, Wilmington, Del., 19898). The properties of electrets and electrostatic filtration have been utilized in air filtration systems.

Some examples of water adhesion gradients and self cleaning surfaces observed in certain systems of plants, such as the lotus flower, and strawberry leaves, have a highly hydrophobic surface due to hydrophobic surface hairs. These surfaces have the effect of removing dust when water droplets strike the surface and carry the dust away in the water droplets.

Conventional Devices

U.S. Pat. No. 5,690,922 Motoya Mouri, et al., “Deoderizable Fiber and Method of Producing the Same”. This patent describes impregnation of fibers with phosphate of trivalent metal hydroxide of a divalent metal and photocatalysts with fibers to give apparel disinfecting and deodorizing properties. This patent mentions adding anti-static agents to the fibers. It does not mention the use of the photocatalysts on non-cloth surfaces or wicking properties. It does not mention using the photocatalysts in conjunction with electret properties.

U.S. Pat. No. 6,592,858 B1 Honda, et al., “Fiber Structure Having Deodorizing or Antibacterial Property”. This patent describes a complex fiber structure that is coated with photocatalyst oxides to achieve deodorant, anti-bacterial, anti-fungal, and anti-soiling properties. This patent also uses silicone oxides with the photocatalysts and the use of zeolites with the photocatalysts. The photocatalyst oxides are attached to the fibers with a variety of resins, such as alkyl silicate resins, silicone resins, and fluororesins. This patent mentions sweat and water absorption properties of the binders. It does not mention electrostatic properties of the binders or photocatalysts.

U.S. Pat. No. 6,685,891 B2 George Benda, et al., “Apparatus and Method for Purifying Air”. Air filtration is described with thermal air flow convection from the lamp-illuminated catalyst to drive an air deodorizer and filter. Humidification above 40% relative humidity and 30% if doped relative humidity, is described to produces hydroxyl ions that kill bacteria. A small water reservoir and wicking of water or other humidification means to maintain humidity is mentioned as an option. An optional filter to remove larger particulate matter is mentioned. This patent does not mention electrostatics or applications to apparel.

US patent application, Publication No. 2003/0180200 A1, Brad Reisfeld, “Combined Particle Filter and Purifier”. This patent about air filtration describes a combined mechanical filtration, deodorization, and periodically washed or disposed of filter for air conditioning and heating systems. This patent does not mention hydrophilic or hydrophobic properties, wicking of water, or electrostatics.

U.S. Pat. No. 6,620,385 B2 Fuji Toishikai, “Method and Apparatus for Purifying a Gas Containing Contaminants”. This patent uses two separate components: a photocatalyst section for decomposing gaseous contaminants, and a HEPA filter using electrets for filtering airborne particles. Toishikai describes the range of suitable photocatalysts, the convertible contaminants, and poisons of the photocatalysts. Electrostatic charging and attraction and trapping hydrocarbon particulates are described to filter particulates. The HEPA filter with the electrets are separate from the photocatalytic section of the system. This patent does not mention hydrophilic or hydrophobic properties, wicking of water, using water to clean, or enhancing the photocatalytic surfaces.

US Patent application, Publication No. US 2003/0179476 A1, Kohayaski Masaki, et al., “Anti-Fogging Element and Method for Forming the Same”. This patent uses the wetting properties of the photocatalyst to form an anti-fogging surface by using photocatalyst and solid polymer paint. This patent describes a method of forming the antifogging coating with the photocatalysts at 200° C. It does not mention hydrophilic gradients, anti bacterial, or electrostatic properties.

US Patent application, Publication No. US 2002/0016250 A1, Hayakawa Makoto, et al., “Method for Photocatalytically Rendering a Surface of a Substrate Super Hydrophilic, a Substrate With a Super Hydrophilic Photocatalytic Surface, and Method of Making Thereof”. This patent describes photocatalytic surfaces that are self-cleaning when surfaces are subjected to rainfall. This patent mentions fogging of eyeglass lenses and the purpose of the wetting film as an antifogging agent. They found the coating thickness of the order of several nanometers is sufficient to render the surface super hydrophobic. This patent describes using the coating to spread water over heat exchanger surfaces to prevent water condensate from blocking fluid flow heat transfer. This patent does not mention hydrophilic gradients, anti-bacterial, or electrostatic properties.

In these references there is no teaching, description or any motivation for using a photocatalyst in conjunction with electrets in apparel.

### SUMMARY OF THE INVENTION

The present invention addresses the shortcomings described above and provides a unique solution to the long-standing problems. The invention combines and optimizes several physical functions into components to achieve the desired effect. This invention incorporates photocatalysts, water adhesion difference surfaces, and electrets to enhance, filter, water wick, disinfect, and deodorize eyewear, air cleaners, and apparel products.

Our research on electrets, which often are also highly hydrophobic materials (polypropylene and silicon rubber), shows that particles that are attracted to them can be removed by water. This is because in the immediate vicinity of the water droplet the electric field is reduced by the inverse of the high dielectric constant of the water (dielectric constant of water is 78 compared to 1 of air at 25° C.), reducing the electric field. The particulate's surface energy is reduced by wetting and incorporation into the water droplet and draws the particulates into the water droplets. Once the water and particles are removed the electric field is restored.

This invention uniquely combines the photocatalyst and electret effects to advantageously create a system for use within eyewear, air cleaners, and apparel items that helps manage gas exchange, liquid water, particulates, deodorize, disinfect, and create the desired comfort to a user.

In our co-pending U.S. patent application Ser. No. 10/317,065, “Non-Fogging Goggles”, incorporated herein by reference in its entirety, we point out that a water-absorbing surface is needed to wet surfaces of the goggles to attract and wick water. We describe using a solid polymer electrolyte as the surface wetting agent. We did not describe photocatalytic properties of the coatings or ionic drag through the coatings.

In our co-pending U.S. patent application No. 60/416,271, “Electrostatic Filtered Eyewear”, incorporated herein by reference in its entirety, we use electrets and electrostatics to filter and hold dust, bacteria, viruses, and funguses. We did not describe photocatalysts used in conjunction with the electrets.

Photocatalysts such as titanium oxide are incorporated into the surfaces of apparel products such a goggles to decompose and oxidize absorbed chemicals on the photocatalyst surfaces with absorption of light with sufficient energy to generate and electron hole pair in the photocatalyst. The electron hole pair leads to decomposition of surface contact with water and subsequent reactive chemicals on the surface of the photocatalysts. The coated surfaces also can function as air filters, air vents, wicking surfaces, protective covers, layers, over underlying materials, and act as ultraviolet light protective filters for the underlying materials and body.

The photocatalysts are hydrophilic surfaces and can be incorporated with hydrophobic layers or adjacent surfaces to act as a water-moving route due to a water adhesion gradient between the two surfaces. The photocatalyst surfaces are also incorporated with an electret or electrostatic charging system to attract and hold dust, bacteria, funguses, and viruses and then subsequently be moved by water on the water adhesion gradient to the photocatalyst surface with the high adhesion to be destroyed by the photocatalytic process.

The photocatalytic surfaces have high water adhesion (surface free energy) due to the production of surface charge on the photocatalyst and the subsequent creation of reactive chemicals on the surface. Oil deposits, that typically will make ambient surfaces hydrophobic, are removed from the surface by the photocatalytic process thus maintaining the surface hydrophilic in nature. This ability to wet can be used advantageously to wet surfaces such as the interior of air vents in goggles to allow condensed water to be wicked away from the vents and out to the perimeter of the goggles.

For the photocatalysts to be effective in the apparel they are located where they can capture the contaminants and receive light and moisture. In the goggle application the photocatalyst coating is on the outer edges of air vents. The geometry and application of the photocatalytic deposits can be coordinated with the hydrophobic and electrostatic areas of the vent in the goggles or apparel to achieve filtration, water removal, and disinfecting decomposition function.

The photocatalyst particles or coating can be imbedded in the surface of the apparel or in a layer within the product while still being accessible by the effective electron hole pair creating photons. Coating a single component such as an air vent or porous membrane with zones of hydrophobic, electret, and photocatalyst can achieve the self-cleaning effects. The photocatalysts protect the hydrophobic surfaces from contaminants that can alter their water adhesion and reduce their hydrophobicity.

The surfaces of the electret can be coated with a discontinuous layer of photocatalyst particles that do to not fully shield the electric field of the electret while the particles are still close enough together to effectively make contact with the photocatalyst when particles are attracted to the electret surface. Grooving, printed strips, channels of hydrophobic and hydrophilic layers, weaves of photocatalytic fibers, electret fibers, and wick fibers, and/or the like, may be used to achieve the self-cleaning and anti-fouling behaviors.

Intimate layers of impregnated fabrics or membranes may be used to achieve the effect. A layering of fabrics for skin contact application such as in a goggle gasket, filters, and in bandages is to have a hydrophobic layer touching the skin or near the skin, while an electret layer and/or a photocatalyst layer is on the outside. To avoid skin irritation from contact with the photocatalyst and to remove water from the surface of the skin, a layering structure is used with the most hydrophobic and less catalytic surface making contact with the skin, while the photocatalysts are on an outside surface.

The hydrophobic contact is also important in bandages where it is desirable to minimize the sticking of the bandage to the wound. To wash apparel and remove particulate build up on the electrets and the photocatalysts, sweat, condensed water, sprayed water, or flowing liquid water droplets in contact with the electret can pull the particulates away from the electret. This is because water has a dielectric constant of 78 at 25° C. in contrast with air with a dielectric constant of 1, and effectively the water contact drops the electric field by a factor of 78.

Thus, the electric field is dramatically reduced with the invention and the particles, by water adhesion, are drawn into the water. The water wicks to the outside of the apparel and can be shed with the particles with it. This means the apparel can be self-shedding and anti-fouling, similar to the phenomenon observed of plants able to clean their surfaces with rainwater such as the lotus flower and the strawberry plant leaves.

Building underlying circuitry and running electricity through the system to achieve ion osmotic drag to move water through or across surfaces is possible. The binding material between the photocatalytic particles can be an electrolyte. Voltages can be applied across the material to actively move water by ionic drag. The electrochemical effects of the photocatalyst can be produced with the applied voltages or enhanced.

Since the photocatalysts are semiconductors it is even possible to electrically connect them as photovoltaic cells and produce useful electricity. If an electrolyte is present between the photovoltaic cells, or electrodes currents between electrodes, it can move water and sweat via ionic current drag. Small amounts of collected electrical energy can be used to run a clock, radio, liquid crystal displays, or lights, and the like.

Color change and opacity in the apparel can also be driven by the photovoltaics imbedded in the photocatalytic layer. The photocatalytic layer with underlying electrodes incorporates liquid crystal materials to affect the polarization of light or light emitters that could be used to produce light filtration or useful displays. Printing patterns of photocatalysts can be used to achieve desired color and appearance effects.

The structure can also have chemical absorbers incorporated in the structure, such as activated charcoal or zeolites, to hold contaminates until that photocatalyst is exposed to blue light and has sufficient humidity to break down the contaminants. In some situations, when the contaminant exposures exceed the photocatalysts' processing rate, the chemical absorbents may act as buffers.

In low humidity environments and applications when the relative humidity drops below 40%, the performance of the photocatalyst is typically reduced. A moisture source could be heated water, sprayed water, wicking material wetted with water, or a selectively permeable membrane containing liquid or water vapor source. In apparel applications in close proximity to the skin moisture content of the air on the surface of the photocatalyst is typically sufficient to obtain a relative humidity above 40% on the surface of the photocatalyst.

In applications, such as but not limited to air filters, humidification at the surface of the photocatalyst may be necessary. Selectively permeable membranes such as urethane membranes or silicone membranes can deliver sufficient water vapor to the photocatalyst in a passive and efficient manner and avoid the problem of precipitate build-up that can occur with boiling, spraying, and wicking delivery of moisture. Selectively permeable membranes that are useful for this application are membranes that let only water vapor through while holding back liquid water. Some non-limiting examples are urethane membranes, silicone rubber membranes, porous polypropylene membranes, porous ceramic membranes, and porous polytetrafluroethylene (PTFE) membranes.

Other applications of this technology are fabrics used and exposed to light sufficient to excite the photocatalysts, with sufficient moisture to activate the photocatalysts, for example, where there is a need for self cleaning, air filtration, clean air exchange, or deodorizing. Some examples are tents, air filters, cat box air cleaners, eyewear, body armor, prosthesis, bandages, gloves, shoes, clothing, furniture, tents, artificial plants, ornamental objects, window curtains, carpets, and vehicle upholstery, wall surfaces, and bulletin boards.

These and further and other objects and features of the invention are apparent in the disclosure, which includes the above and ongoing written specification, with the claims and the drawings.

### BRIEF DESCRIPTION OF THE DRAWINGS

FIG. 1 is a cross-sectional view of the titanium dioxide coating in a chevron goggle air vent, electret substrate, and hydrophobic zone.

FIG. 2A is an interior view of a goggle with hydrophobic, electret, and photocatalytic zones on the lens and face gasket.

FIG. 2B is a side view and cut out of a goggle with chevron vent with hydrophobic and electret coatings.

FIG. 2C is a bottom view of goggle showing the chevron vents with photocatalytic coating.

FIG. 3 is an enlarged side cutaway view of the chevron vent showing hydrophobic and electret surfaces in the chevron vent and the lens.

FIG. 4 is an enlarged view of the interior surface of the lens and face gasket.

FIG. 5 is an enlarged cross-sectional view of a coated fiber structure of the photocatalyst, electret, and hydrophobic areas.

FIG. 6 is an exploded cross-sectional view of an air and deodorization filtration system using an artificial light source, and a membrane water vapor delivery system.

FIG. 7 shows clothing apparel on a human showing the usage areas for a photocatalytic, electret, hydrophobic fabric, or structure.

FIG. 8 shows an adhesive bandage using a photocatalytic, electret, hydrophobic fabric, or structure.

### DETAILED DESCRIPTION OF PREFERRED EMBODIMENTS

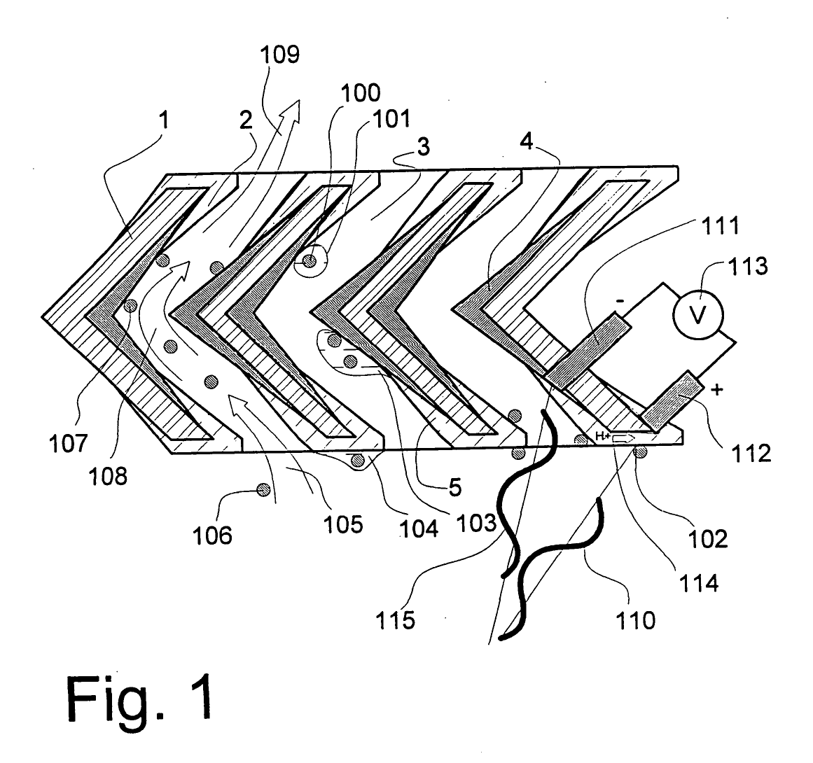

In FIG. 1 a chevron vent used, for example, in goggles, body armor, or a protected air intake is shown. This vent 1 is formed by molding silicone rubber, polypropylene or polystyrene or a suitable material including metals, composites of metals fibers plastics or rubbers. The silicone rubber, polypropylene, and polystyrene and/or suitable material are electrets 4. The molded shapes 1 are formed typically to block direct projectiles and allow high air flow rates.

In the interior of the structure 1 the electret 4 attracts charged particles and dust 106 and holds particulates 107 on the surface of the electret 4. If the chevron channels 3 are formed out of metal a silicon rubber coating can be applied to the metal component to give the metal an electret layer 4. A hydrophobic coating 2 such as, for example polytetrafluroethylene (PTFE), is deposited by plasma polymerization on one side of the structure 1. The hydrophobic coating 2 only penetrates partially into the flow channels 3 of the chevrons 1.

On an opposite side of the hydrophobic film 2, and typically the exterior side of the vent 1, a photocatalyst 5 such as, for example titanium dioxide particulates, are spray deposited with a binder such as silicone rubber, or the titanium dioxide may be sputter deposited. One example of a specific coating is a mixture of 32 nm particles of titanium dioxide anatase form (Alfa Aesar, 26 Parkridge Road, Ward Hill, Mass., 01935-6904), mixed with Nafion® (Solution Technology, Inc., PO Box 171, Mendenhall, Pa., 19357). The solvent is evaporated and leaves the catalysts surrounded by a thin film of the fluropolymer electrolyte 0.03 to 5 microns thick. An alternative commercially available spray coating is TPXsol (Green Millennium, Inc., 20539 E. Walnut Dr., Suite B, Diamond Bar, Calif., 91789).

This deposit only partially coats the flow channel 3 of the chevron. The vent structure 1 can have electrodes of gold, platinum, palladium, tin oxide, zinc oxide, or nickel electrodes 111, 112 built into or plated onto the surfaces of the vents. These electrodes are coated with a photocatalytic coating 5 to create electrochemical cells across the surface of the vents or through the vents 1. External circuits 113 can be connected to the electrochemical cells to create a voltage across the electrodes 111, 112 or utilize voltage and current from the electrochemical cell. These electrochemical cells in the vent can also be configured with electronics 113 to be a chemical or humidity diagnostic tool.

During operation air flows 105, 108, 109 through the chevron structure 1. Small dust and particulates 106 which are typically charged are attracted by the electric field of the electret 4 and held by the electret surfaces 4. Larger particles 107 are captured or deflected by the turn in the chevron structure 1. Snow or rain will impact and stick to the sides of the flow channels 3. Water droplets 101 from spray, rain, snow, or condensation on the surfaces of the chevrons 2, 4, 5 will decrease the electric field of the electret 4 by a factor of roughly 1/80 because of the high dielectric constant of water compared to air. The water droplets 101 will include the particulate particles 100 that were sticking to the electret 4.

Most of the electrets 4 are very hydrophobic and as a result the water droplets 103 will bead on the surface and tend to move along the hydrophobic hydrophilic gradient setup by the hydrophobic coating 2 at one end of the flow channel 3 and the hydrophilic photocatalyst 5 at the other end. The coatings 2, 4, 5 may be deposited so that water adhesion properties gradually go from low adhesion (hydrophobic i.e., low free surface energy) to high adhesion (hydrophilic i.e., high free surface energy) on the photocatalyst 5. This process moves entrapped particulates 107 from the electret 4 to the outer photocatalytic surface with the water droplets 104.

The particulates with the water on the outer surface 104 with blue light photons 110, with wavelengths shorter than 387 nm, are absorbed into the semiconductor titanium dioxide above the 3.2 eV band gap energy of photocatalyst, and water reactive hydroxide ions are created on the photocatalyst surfaces 5. These react with the dust particles oxidizing a variety of organic and inorganic compounds. This oxidation can kill bacteria, funguses, and viruses on the photocatalytic surfaces 5. This also leads to deodorization by directly oxidizing the aromatic hydrocarbons or the odor producing bacteria or funguses.

The electrodes shown in FIG. 1 have photocatalytic or catalytic surfaces. Light 115 induces hydrogen and hydroxide ions to be created on the surfaces of the electrodes 111, 112 in the surface water 104 in the vent, or in the electrolyte photocatalytic film 5 on the surface of the vent.

This photocatalytic process creates a voltage between the two electrodes 111, 112 from a variety of effects such as photovoltaic, chemical concentration differences, or humidity differences between the electrodes 111, 112. With sufficient light and an efficient design these voltages can be used as an electrical power source or diagnostic probe such as, but not limited to, measuring relative humidity in the vent, sensing chemicals encountered in the air flow, and detecting light exposure.

A voltage from a power source 113 such as a battery can be induced across the two electrodes to produce an electro-osmotic driver of moving ions 114 between the electrodes and can be used to move water 103, 104 in or out of the vents. The voltage can periodically pulse to electrochemically clean the surfaces of the vents 1 by creating oxidative chemicals similar to what was produced with light on the photocatalyst. It is also possible to produce, heat, light, or liquid crystal light polarization in the film between the electrodes 111,112.

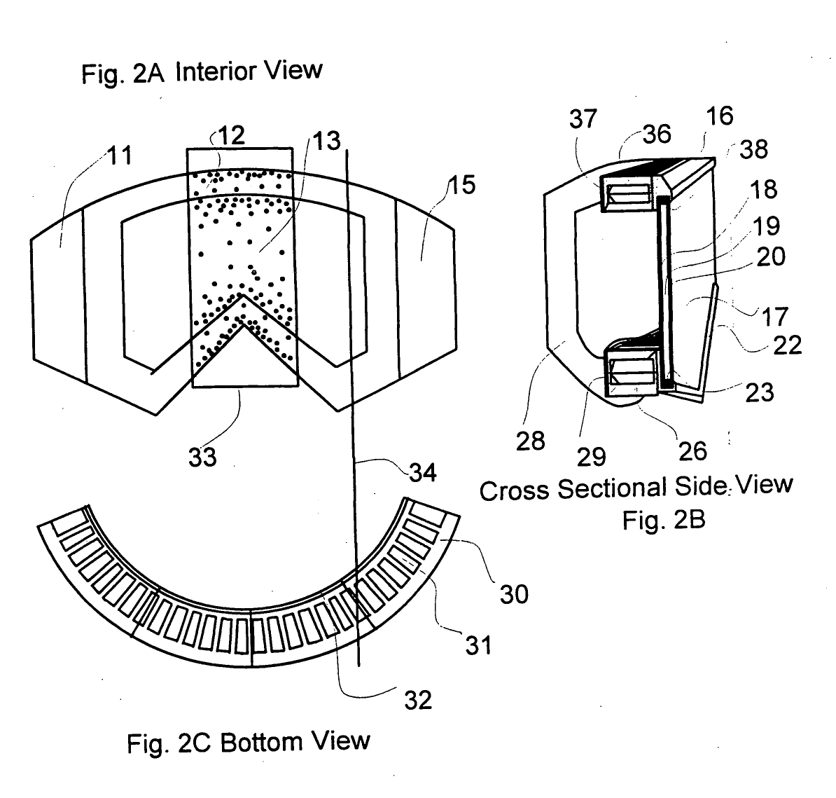

In FIG. 2A the interior view of a goggle is shown. The goggle is formed with a urethane or polycarbonate plastic lens 13, silicone rubber frame, 11, 15 and a face gasket of polypropylene 12. Many of these materials are electrets such as silicone rubber, polycarbonate plastic, and polypropylene. Thin layers of materials with index of refraction changes are typically coated onto the lens 13 to give them anti reflective properties.

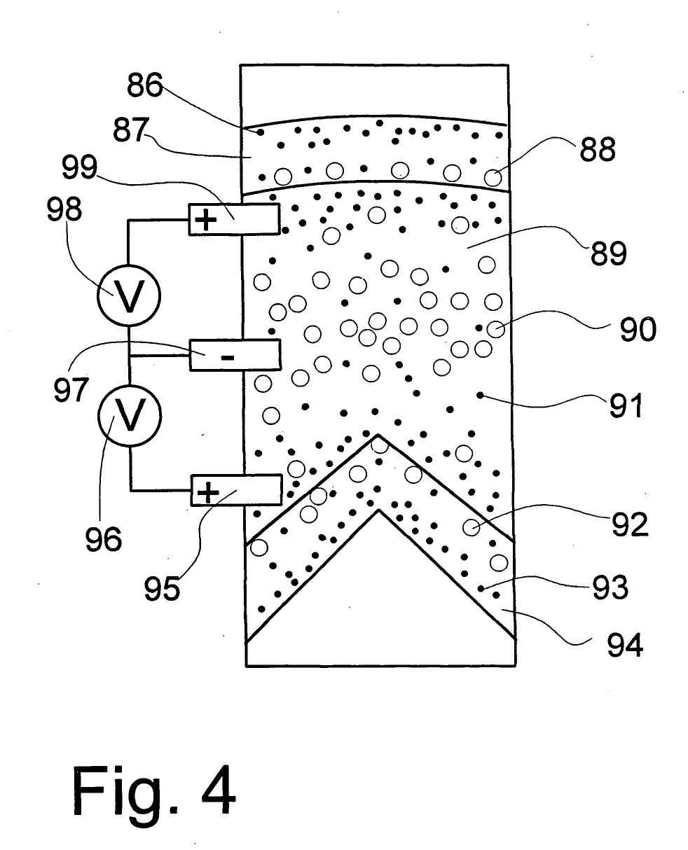

Inner and outer surfaces of the lens are coated with a hydrophobic coating in the central region of the lens 13 making the central region of the lens more hydrophobic. The face contact gasket 12 is coated on the interior with a hydrophobic coating and on the exterior with a hydrophilic coating. An expanded view 33 of the lens and face gasket is shown in FIG. 4

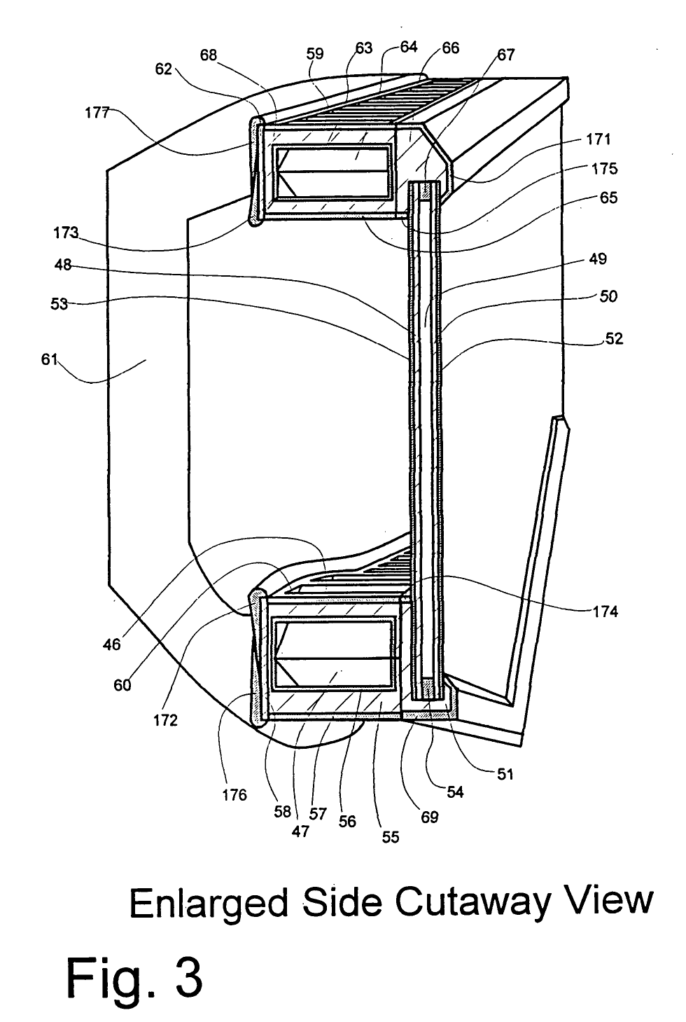

In FIG. 2B a side view of the goggle with a cross-sectional cutout of the air vents and lenses is shown. The lens 17 with an interior lens 18 and exterior lens 20 forms a double lens 17. Polycarbonate plastic double lenses 17 are held apart to create an insulating air gap 19 between the lens with a closed cell urethane plastic foam 23, 38 and framed by a urethane or silicone rubber goggle frame 16, 22. The lower vent 26 is a cross-section and has a chevron structure molded out of silicone rubber, which is an electret. The upper air vent 36 is built into the upper portion of the frame 16. The vent channels 36 are coated with a plasma polymerized polytetrafluroethylene (PTFE) to achieve hydrophobic surfaces on the interior of the frame and vent channels 36, and a titanium dioxide coating on the vent channel inlets and exterior of the vents 26. The face gasket 37, 28 is shown covering the vent channels 36. An expanded view of the vent cross-section is shown in FIG. 3.

FIG. 2C is a bottom view of the goggle air vent inlets 31. The frame 30 is coated with photocatalyst and has inlet channels 31. The face contact gasket 32 is on the outer surface of the frame 30.

In FIG. 3 an enlarged cross-sectional side view of the goggle vents and lenses are shown. The goggle frame 51, 66 hold the inner and outer lenses apart with spacer foam 54, 67 to create an insulating air volume 49. The outer lens 50 is coated with a hydrophobic and hydrophilic coating 52 patterned as shown in FIG. 4. The inner lens is coated with a hydrophobic and hydrophilic coating 53 with a similar or the same pattern as shown in FIG. 4. Built into the frame or made as inserts into the frame 51, 66 of the goggles or face gasket are the air vents. Lower and upper air vents are shown.

In operation when air temperature is lower than 37° C. air passes through the lower vent channels 46 and is heated from body heat transferred from the chevrons 55. The chevrons are heated through the face gasket 58 in contact with the user and through the thermal conduction into the chevron vent structure 55. The heated air rises due to its buoyancy past the inner lens 48 and the user's face, carrying heat and moisture from the face of the user. This removal of heat and moisture keeps the inner lens 48 from fogging under most operating conditions and keeps the user comfortable.

When condensation does occur on the inner or outer lens 48, 50, frame 66, 51, or vents 55, 68, such as when the goggles are chilled and the interior or exterior air is saturated with moisture at a much higher temperature than the lenses 48, frame 51, or vent 55, 68, the photocatalytic coating on the inner lens 53, frame 69, 174, 175, 171, and vents 57, 62 wets and moves water toward the perimeter of the lenses 48, 50, frame 51, 66 and vents 55, 68 due to the water adhesion gradient as shown in FIG. 4 and FIG. 1.

Warm moist air exits the top of the goggle through the upper chevron flow channels 64. The upper chevron vents 68 are formed out of an electret silicone rubber. On the inner sides of the vent 68 adjacent the inner lens 48 the vents have a hydrophobic coating 65 such as plasma polymerized polytetrafluroethylene. The top face gasket inner surfaces 61, 62 adjacent to the inner lens 48 are coated with a hydrophobic coating such as plasma-polymerized polytetrafluroethylene. The outer surfaces of the vents 55, 68 are coated with 30 nm titanium dioxide particulate suspension in a polysilicone rubber binder coating 57, 59.

The chevron vents 68, 55 are designed to block straight-line projectiles. The smaller particulates in the air stream flowing through the vents are attracted to the walls of the chevrons by the electrostatic field of the electret coating 56, 63 or material 55, 68 of the chevrons attracting and holding the particulates. The vents 68, 55 are cleaned and deodorized in the process as described earlier and illustrated in FIG. 1.

The electret silicone rubber inner surfaces of the frame 51, 66 face gasket 58, 62, and the vent surfaces 47, 64 are coated with plasma polymerized polytetrafluroethylene 60, 172, 65, 173. The outer perimeter surfaces of the frame 51, 66, vents 55, 68, and gasket 58, 62 are coated with 30 nm titanium oxide particles and a polysilicone rubber binder 69, 171, 57, 176, 62, 177. A discontinuous coating of the photocatalyst 69, 171, 57, 176, 62, 177 on the surface of the hydrophobic coatings 60, 172, 65, 173 and electrets 56, 63 on the inner surfaces has some desirable wetting and photocatalytic properties. Other structures such as, but not limited to, a random fiber structure or open cell foam could be substituted for the chevron structure with the adjacent zones of hydrophobic, electret, and photocatalytic surfaces.

FIG. 4 is an expanded view of the interior lens and face gaskets. The electret lens 89 is made of polycarbonate or urethane plastic, and a woven electret polypropylene 87 face gasket are shown. A hydrophobic coating on the lens is represented as circles 90 with a higher spatial concentration in the surface center region coats the lens 89. This coating 90 can be blended into, or coated over the last coating, of the anti-reflective coating on the lens or be atomically thin enough such that it essentially has very little optical effect but decreases the adhesion (hydrophobic).

For example, a titanium dioxide coating represented as black dots 91 with a higher spatial concentration at the perimeter of the lens 89 is either blended into the last anti-reflective coating, or is coated over the previous hydrophobic coating 90, thin enough that it has very little optical effect, but increases the adhesion (hydrophilic) toward the central surface regions of the lens 89. These hydrophobic and hydrophilic coatings 90, 91 are arranged to create a water adhesion gradient of low adhesion (hydrophobic) on the interior region to a high adhesion on the perimeter (hydrophilic) of the lens 89.

On the face gasket 87, 94 is a water wicking fabric such as silk or Cool Max® (DuPont Corp., 1007 Market Street, Wilmington, Del., 19898), or a woven polypropylene typically covering an open cell foam on the goggle interior. The goggle interior is coated with a low adhesion material 88, 92, such as plasma polymerized polytetrafluroethylene (PTFE) (hydrophobic) or silicone rubber (hydrophobic and electret). On the outer perimeter region of the gasket the fabric 87, 94 is coated with titanium dioxide particles 86, 93 held with a binder such as TPXsol (Green Millennium, Inc., 20539 E. Walnut Dr., Suite B, Diamond Bar, Calif., 91789).

The hydrophobic coating 88, 92 coverage of the surface gradually declines toward the perimeter of the gasket 87, 94 while the hydrophilic coating 86, 93 coverage of the surface gradually increases toward the perimeter of the gasket 87, 94. This produces a water adhesion gradient across the gasket 87, 94 that, when illuminated by light above the band gap of the photocatalyst (3.2 eV of the anatase form of titanium dioxide), creates a high adhesion on the perimeter and a low adhesion on the interior of the gasket 86, 94. Condensed water will move from a low adhesion surface to a high adhesion surface. By moving the condensed water away from the central areas of the lens to the perimeter of the goggle, visibility is improved through the lens 89.

The water movement also carries with it particulates that were attracted and held by the lens electret 89 and gasket electret 87. In this example, the urethane or polycarbonate lens 89 and polypropylene fabric or silicone rubber coated silk or Cool Max® 94, 87 is an electret. By moving the condensed water and sweat off the skin contact areas of the gasket to the perimeter of the gasket the comfort to the user is improved by allowing air to reach the surface of the skin. On the perimeter of the gasket 87, 94 the water can be evaporated to the atmosphere.

The contaminates such as bacteria, dust, viruses, funguses, and body oil that were carried with the water come in contact with the photocatalyst surface. When the photocatalyst is illuminated with the blue light it produces electron hole pairs. The free electrons migrate to the surface of the photocatalyst and with a surface catalyst such as platinum or the titanium oxide, electrolyses water and creates hydroxide ions on the surface of the photocatalyst and the water. The hydroxide ions oxidize the contaminants, thus cleaning the perimeter of the lens face 89 and contact gasket 87, 94.

Thin film electrodes of materials such as titanium, titanium dioxide, tin oxide, zinc oxide, Au, Pt, Pd, Ni, can be printed across on the lens 89 as shown in FIG. 4. These electrodes 95, 97, 99 have photocatalytic or catalytic surfaces. Light induced hydrogen and hydroxide ions are created on the surfaces of the electrodes 95, 97, 99, in the surface water, or in the electrolyte photocatalytic film 91 on the surface of the lens 89.

This photocatalytic process creates a voltage between the central electrode 97 and the perimeter electrodes 95, 99 from a variety of effects such as direct photovoltaic voltages, chemical concentration differences, or humidity differences between the electrodes. With sufficient light and an efficient design these voltages may be used as an electrical power source or diagnostic probe, such as, for measuring relative humidity on the lens 89, sensing chemicals encountered in the air flow, and detecting and responding to light exposure.

A wide variety of electrodes 95, 97, 99 and patterns could be deposited onto the lens 90 for various functions. A voltage from a power source 96, 98 such as a battery can be maintained across the two electrodes to produce an electro-osmotic driver of moving ions between the electrodes to move water out of the central region of the lens 89 to the perimeter wicking gasket 87, 94.

The voltage can be periodically modulated to electrochemically clean the surfaces of the lens 89 by creating oxidative chemicals similar to what was produced with light on the photocatalysts 91. It is also possible to produce heat, light, changes in reflectivity or light absorption, liquid crystal light polarization, and the like, in the film between the electrodes 95, 97, 99 with electrical and ionic currents for water removal, image displays, indicators, and light filtration.

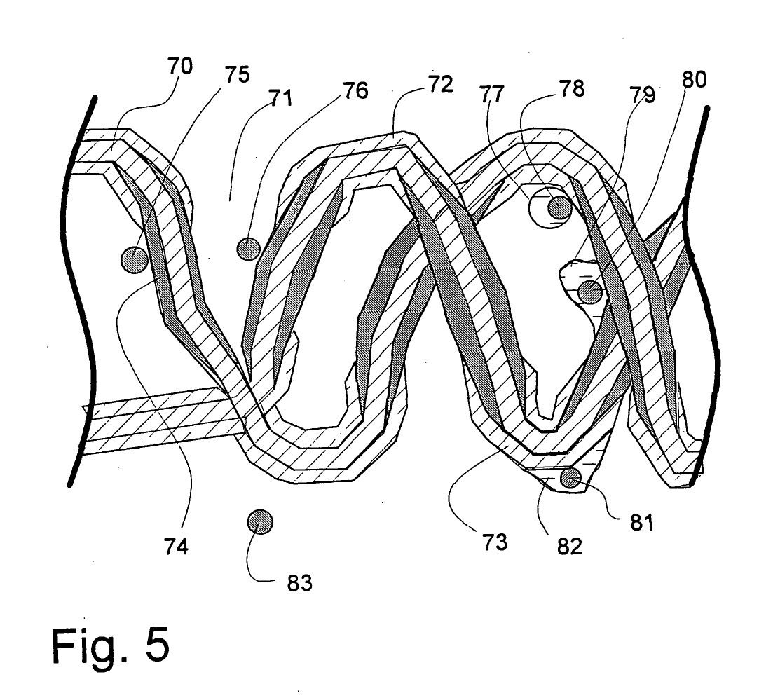

FIG. 5 is a cross-sectional view of the fibers of a fabric. The fibers 70 are coated such that there is an electret zone 74 in the interior of the fabric, a hydrophilic zone 73 on one outer surface, and a hydrophobic zone 72 on the opposite outer surface. The electret zone 74 can be created by fibers such as polypropylene, polystyrene, or polyvinylidenefluoride (PVF₂), these being charged electrets, or being coated with an electret such as silicone rubber. Coating one surface of the fabric with a film such as plasma-polymerized polytetrafluroethylene creates the hydrophobic layer 72. On the opposite surface of the hydrophobic coating 72 a photocatalyst such as titanium dioxide particles, for example 32 nm in diameter, is sprayed onto the surface of the fibers with a solution of a monomer of Nafion® dissolved in alcohol solvents (Solution Technology, Inc., PO Box 171, Mendenhall, Pa., 19357) is coated 73 onto the fibers 70.

Other variations of this construction include use of a fibrous or porous membrane material 70 such as polypropylene or polyvinylidenefluoride (PVF₂) that is a charged electret and is hydrophobic, and then coat 73 just one surface of the fabric or membrane 70 with titanium dioxide particles with a silicone rubber or fluorocarbon binder.

The fabric 70 can be used in a variety of applications such as, but not limited to, outer fabric shell of clothing. The fabric could be touching the skin or separated from the skin by layers of fabric such as Cool Max® or thermal insulation such as Thinsulate® (DuPont Corp., 1007 Market Street, Wilmington, Del., 19898) fill.

Air 71 will diffuse through the fabric 70 allowing the water vapor to leave the surface of the skin of the user and allow air to flow and diffuse in and out of the clothing. This diffusion maintains a comfort in the clothing to the wearer of the clothing.

Along with the flow of air 71 and in general contact with surfaces, dust, particulates, bacteria, funguses, and viruses 83 will penetrate the fabric. They will be attracted to the electret surfaces 74 and be held in the fabric 70. When exterior temperatures are low and the user is emitting a high moisture rate the dew point inside the fabric shell can be reached and water 77, 79, 82 will condense on the hydrophobic 72 and electret 74 surfaces. Water 77, 79, 82 can also be splashed or driven into the electrets 74 and hydrophobic surfaces 72 from rain and snow.

The condensed water droplets 77, 79, 82 will reduce the field strength of the electret 74 pick up the contaminants 83 such as dust, hydrocarbons, and particulates 75, 76 held by the electrets 74 and hydrophobic surfaces 72. The water droplets 77, 79 containing the particulates 78, 80 will be driven by the water adhesion gradient toward the higher adhesion photocatalytic outer zone 73. On the outer surface 73 the water 82 can evaporate and leave behind the contaminants 81 in contact with the photocatalysts 73.

Sunlight or blue light absorbed above the band gap in the photocatalyst 73 create electron hole pairs and chemically active surface hydroxides by electrolysis with a surface catalyst and a surface contacting water 82. These hydroxides oxidize the contaminants resting on the photocatalyst surfaces, thus, decomposing the contaminates 81 and disinfecting and cleaning the surface 70 of the fabric shell.

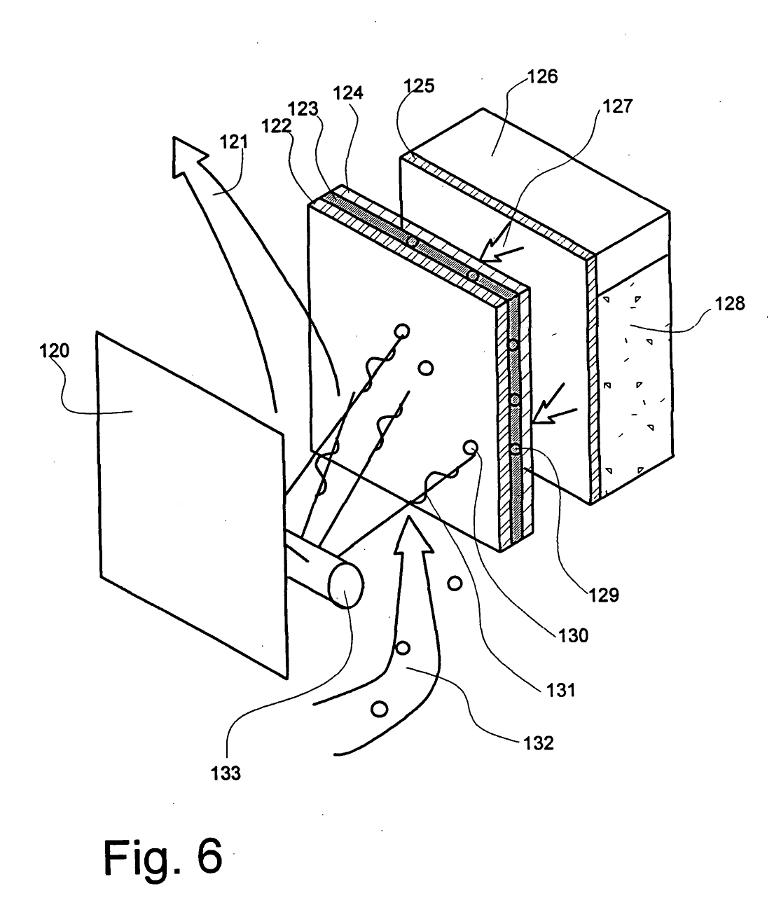

In FIG. 6 an air cleaner arrangement is shown. In this arrangement the fabric 122, 123, 124 just described in FIG. 5 is placed over a moisture delivery source 127, 125, 126, 128. The fabric 122, 123, 124 consists, for example, of three layers: a photocatalytic layer 122, electret layer 123, and the hydrophobic layer 124. The hydrophobic layer 124 is placed nearest the source of moisture 127. The photocatalytic layer is placed near the source of blue light 133. The moisture source 127 is a membrane or water-retaining barrier 125 with a reservoir of water 126, 128 behind the barrier 125. Suitable membranes and water barriers 125 are, for example, urethane membranes approximately 0.002 inches thick supported on a plastic coated fiberglass mesh or silicone film 0.002 inches thick over a porous alumna tube or plate, capillary silicone tubing, or a porous clay pot.

A possible alternative arrangement is to use the fabric of the three layers, photocatalytic layer 122, electret layer 123, and the hydrophobic layer 124, for forming the water barrier membrane 125 with the water 128 in direct contact with the hydrophobic layer 124.

The blue light source is a fluorescent tube 133 designed to produce light with photons exceeding 3.2 eV, or light emitting diodes producing light photons over 3.2 eV. The light source 133 is placed over the photocatalytic layer 122 of the fabric to illuminate the photocatalyst. A reflector and air duct 120 is placed behind the light source 133 to duct the air 132, 121 over the photocatalyst 122.

An alternative arrangement is to have two photocatalytic fabrics 122, 123, 124 with moisture sources 125, 126, 128 in parallel to each other forming an air flow and light channel between them. Air 132, 121 can also flow past the moisture source 127, through the fabric 125, 126, 128, out through the channel 121. An alternate arrangement is to have the fabric covering a tube or container filled with water having a retaining membrane to make a decorative air cleaner. Sunlight or artificial light 131 can illuminate the photocatalyst 122 of the fabric. Air flows 132, 121 across the photocatalytic surface.

The airflow channel width and length above the surface of the photocatalyst can be chosen to optimize the diffusion and filtration needed for the particular application to disinfect and clean the air stream 132, 121. The air 132, 121 can flow by using thermal convection from the light 131 heating the photocatalyst and air flowing 121 air past the photocatalyst 122 in a chimney, or could be free surface convection across the surface of the photocatalytic fabric 122. Airflow 132, 121 could also be forced across or through the photocatalytic surface 122.

The moisture source 125, 126, 128 delivers water vapor to the surface of the photocatalyst 122 by diffusion 127 or, if there is a low air flow rate 121, through the fabric from the moisture source 125, 126, 128. Alternative moisture sources could be to spray moisture into the input air stream 132, such as with piezo electric atomizers, and flow into the photocatalytic surfaces 122. This moisture delivery scheme could be used periodically to create water droplets on the hydrophobic surfaces 124 and electret surfaces 123 of the filters to clean the filter.

Water spray systems could also be used when air filtration and humidification are desired. The water sprays could be controlled with relative humidity sensors to maintain the photocatalyst's 122 optimum humidity. The water spray system can have excessive salt from the water source and dust build up in systems where dust removal is not the primary purpose.

The water retaining membrane 125 delivery system can be used when pure water vapor is desirable along with non-active operation without pumps or controls. The membrane system can periodically be cleaned by causing water to condense on the fabric hydrophobic surfaces 124. This can be accomplished by periodically cooling the exterior of the fabric to reach the dew point, blocking the air flow with exterior cooling, or heating the water reservoir to the dew point in the fabric 122, 123, 124.

The water retaining membrane scheme can also have a higher water utilization efficiency because the moisture is diffused 127 under the photocatalyst to create a local high humidity with the contaminates 129 being drawn by electrostatic attraction, or diffused into the fluid boundary layer over the surface of the fabric 122, 123, 124. Thus, there would be no need to humidify the whole air stream to accomplish extracting the contaminates 130 and maintaining optimum humidity on the surface of the photocatalyst 122.

In operation, the air cleaner would have a light source 133 such as a light emitting diode, thermal convection air flow 121, or a fan and water filled reservoir 128. Moisture would diffuse 127 through the liquid retaining membrane to the surface of the photocatalyst. In the air flow stream 132 are particulates and contaminants 130 such as dust bacteria, funguses, viruses, ammonia, hydrocarbons, aromatic hydrocarbons, and oils. These contaminants 130 flow past the surface of the fabric. The charged particulates 129 are attracted to the oppositely charged areas of the electret 123.

Planar electrets 123 can be charged with alternate areas of positive and negative charges. Most submicron diameter particulates are charged. The particulates lodge on the electret zone 123 of the fabric. Gaseous contaminants 130 such as ammonia are absorbed on the surface of the photocatalysts 122. Activated charcoal could also be added adjacent to or mixed with the photocatalyst 122 to act as a buffer to absorb gaseous contaminants and allow the photocatalyst 122 to steadily decompose the contaminants over time.

Sunlight or blue light 131 absorbed above the band gap in the photocatalyst 122 create electron hole pairs and chemically active surface hydroxides by electrolysis with surface catalysts and surfaces contacting water. These hydroxides oxidize the contaminants 130 resting on the photocatalyst surfaces, thus, decomposing the contaminates, disinfecting and cleaning the surface of the fabric 122.

Periodically liquid water is either condensed or forced on the electret surfaces 123, this carries particulates 129 to the hydrophilic photocatalyst surface 122. Some of the particulates 130 are decomposed to gases such as carbon dioxide and water, but the remaining solids agglomerate and fall off the surface of the photocatalyst 122 or can be mechanically removed. This air cleaner can be used in a wide variety of applications such as, but not limited to, building air filtration, animal cage air deodorizing, cat litter box air deodorizing, and ornamental air cleaners (simulated plants, art work, and fountains).

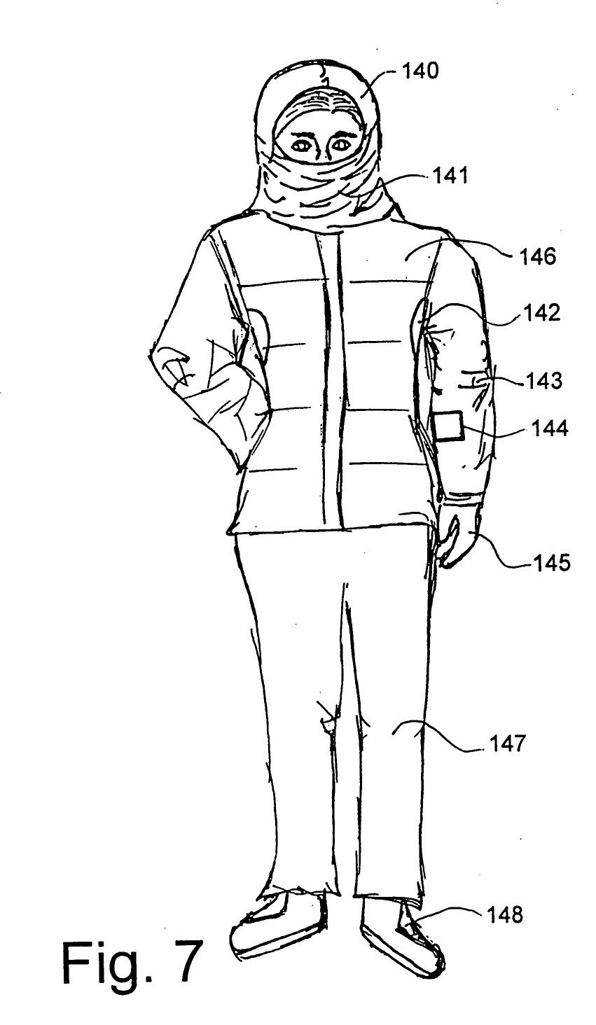

In FIG. 7 the fabric shown in FIG. 5 can be used in apparels for a human. In FIG. 7 a jacket 143, 146 has an outer shell of fabric made with hydrophobic, electret, and photocatalytic layers. The photocatalysts act as UV filters to protect the underlying fabrics and the human being. The hood 140 of the jacket 146 and a breathing filter 141 may also use this fabric. In the breathing filter 141 the human can breath through the filter and the electret would capture small dust particles.

When air from the human produces condensation on the hydrophobic surfaces and electret surfaces, the particulates are carried to the outside of the fabric. Sunlight or blue light would then disinfect and clean the outer surfaces of the fabric while in use and after use. Hydrophobic, electret, and photocatalytic layered fabrics can also be used in bandages 144.

Photocatalytic fabrics along with activated charcoal can also be used in specific areas such as in the underarm area 142 to absorb odors and to deodorize clothing 146, 143. The vent structure shown in FIG. 1, such as in body armor can be used, rather than a fabric, if higher airflow is needed in specific areas of the apparel 146, 143, 147, 148, 145, 141, 140. The water migration ability of the photocatalytic fabric in general can be effective throughout the clothing to move moisture from the surface of the skin.

Hand gloves 145, or socks, can have an outer shell of photocatalytic fabric to deodorize, allow water vapor and sweat to be removed from the hands, keep the hands dry, and disinfect the gloves 145. By keeping the hands dry with the water adhesion gradient process to move water and contaminates to the outside of the glove 145, it increases comfort to the user and reduces the bacterial and fungus food supply on surfaces inside the glove where they can grow.

The pants 147 of apparel can have an outer fabric shell of the photocatalytic fabric. The water migration behavior can improve the comfort of the user especially when the user has stepped into water or urinated into the pants. The liquids will be moved to the outside surface and be gradually evaporated and disinfected with exposure to blue light. The air breathing portions of the shoes 148 can have the water migration ability and use the photocatalytic effect to deodorize and disinfect the shoes 148 while being worn, or while they are not being used with exposure to blue light.

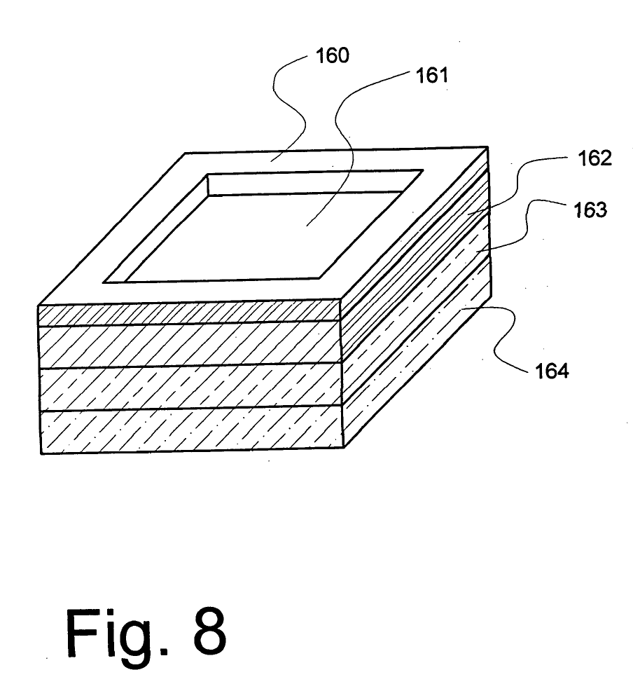

FIG. 8 shows a bandage constructed using the fabric shown in FIG. 5 and shown applied to a human in FIG. 7. In FIG. 8 an adhesive coating 160 is applied to an area on the hydrophobic side of the fabric 161. The selection of the adhesive requires that the adhesive 160 bond to the hydrophobic surface 160 and also adhere and seal the perimeter against any bacteria, particulates, funguses, and viruses to the human while minimizing damage to the skin and allowing the skin to release moisture, carbon dioxide, and receive oxygen. Examples of these adhesives include, but are not limited to, hydrophilic polymers such as karaya gum, gum acadia, locust bean gum, polysaccharide gum, modified polysaccharide, or polyacrylamide.

The hydrophobic surface 161 with the adhesive perimeter 160 is placed on the skin or wound of the user. The most photocatalytic surface 164 is on the outside. The photocatalyst 164 can also act as a UV blocking protector to the skin or wound. The bandage 164, 163, 162, 160 can be wetted on the outside and immersed in water and the water will not penetrate the bandage. Liquid blood and body fluids beneath the bandage 164, 163, 162, 160 would be drawn through by the hydrophobic-hydrophilic gradient to the outside of the fabric.

On the outside surface 164 of the bandage conventional fabric absorbents such as cotton gauze can be used to absorb the fluids. The purpose of the bandage 164, 163, 162, 160 is to drain excess fluids away from the wound in an irreversible manner and not allow contaminated fluids to return to the wound. The photocatalyst coatings can be lightly dispersed throughout the bandage 164, 163, 162, 160 at sufficient levels to achieve sterilization of the surfaces, while still having the photocatalyst coating gradient toward the outside to achieve the preferential movement of liquid fluids.

By having the most hydrophobic surfaces 161 (polytetrafluroethene or polypropylene) in contact with the wound the lowest sticking coefficient surfaces are touching the wound. Thus, a bandage sticking to a wound and interfering with a wound's healing process is minimized. The bandage 164, 163, 162, 160 can be removed from the wound with a minimum of resistance. Dust, bacteria, viruses, and funguses would be filtered by the electret layer 163 of the fabric used in the bandage and sterilized by the photocatalytic effect with exposure to blue light. The pore size of the fabric can be designed smaller than that of bacteria and fungus spores and not allow them through the membrane 162, 163, 164.

Molecularly selective permeable membranes (pore sizes or spaces between molecules in the material that will exhibit selective permeability to molecules), such as silicon rubber or urethane rubber membranes, can be the hydrophobic layer 162 of this fabric to achieve a barrier to large molecules, bacteria, funguses, and viruses. The selectively permeable layer 162 would be thin enough (typically less that 50 microns), to achieve high diffusion rates and the remainder of the fabric would provide mechanical support for the membrane.

The self cleaning features of the outer layer of fabric 163, 164 are useful as a protective barrier to the inner membrane 162 and secondary barrier if the selectively permeable barrier 162 is breached. Photocatalysts can be incorporated with the selectively permeable layer 162 to make it self-sterilizing with exposure to blue light. These fabrics 162, 163, 164 can also be used in diapers.

List of Figures and Element Numbers

FIG. 1 Cross sectional view of the titanium dioxide coating in a chevron goggle air vent, electret substrate, and hydrophobic zone.
1. Air vent structure
2. Hydrophobic coating
3. Air flow channel
4. Electret coating
5. Photocatalyst and hydrophilic coating
100. Particle inside water droplet
101. Water droplet with a high contact angle on hydrophobic surface
102. Deposited particle on outer photocatalytic surface
103. Low water droplet contact angle on the photocatalytic surface
104. Low water droplet angle on outer photocatalytic surface
105. Incoming air flow
106. Particle in air
107. Particle attracted and held by electret surface
108. Air flow in chevron flow channel
   Air flow in goggle interior
   Blue light photons interacting with the photocatalytic surface
111. Negative electrode
112. Positive electrode
113. Voltage source
114. Hydrogen in electrolyte
115. Photon exciting the photocatalysts on the electrode

FIG. 2A: Interior view of a goggle with hydrophobic, electret, and photocatalytic zones on the lens and face gasket.
11. Frame of goggle coated with photocatalyst
12. Cloth face contact gasket coated with photocatalyst
13. Interior of lens coated with hydrophobic film and photocatalyst
15. Frame of goggle coated with photocatalyst
33. Enlarged view area of interior of lens and gasket

FIG. 2B Side view and cut out of a goggle with chevron vent with hydrophobic and electret coatings.
16. Frame of goggle coated with photocatalyst
17. Exterior lens of goggle coated with photocatalyst
18. Inner lens
19. Air gap between lenses
20. Outer lens coated with photocatalyst
22. Frame of goggle
23. Spacer foam separating lenses
26. Chevron vent structure
28. Face gasket
   Face gasket coated with photocatalyst
   Chevron vent structure
   Face gasket coated with photocatalyst
   Spacer foam separating lenses

FIG. 2C: Bottom view of goggle showing the chevron vents with photocatalytic coating.
30. Frame of goggle coated with photocatalyst
31. Flow channel entrance coated with photocatalyst
32. Interior face gasket coated with photocatalysts
34. Cross sectional line cut.

FIG. 3: Enlarged side cutaway view of the chevron vent showing hydrophobic and electret surfaces in the chevron vent and the lens.
46. Interior vent flow channel coated with a hydrophobic film
47. Air flow channel
48. Interior lens
49. Air volume between lenses
50. Exterior lens
51. Goggle frame
52. Photocatalytic coating on exterior of lens
53. Photocatalytic coating on interior of lens
54. Foam spacer between inner and outer lens
55. Structure of the chevron air vent
56. Electret coating on chevron flow channel
57. Photocatalytic coating on the exterior of the chevron
58. Photocatalytic coated face gasket cross-section
59. Photocatalytic coating on exterior of the chevron vent
60. Hydrophobic film
61. Face gasket
62. Photocatalyst coated face gasket
63. Electret coating on chevron
64. Airflow channel
65. Hydrophilic coating on interior of chevron vent
66. Goggle frame
67. Foam spacer
68. Structure of chevron
69. Photocatalytic coating on frame
171. Photocatalytic coating on frame
172. Hydrophobic coating on face gasket
173. Hydrophobic coating on face gasket
174. Photocatalytic coating on inner frame
175. Photocatalytic coating on inner frame
176. Photocatalytic coating on face gasket
177. Photocatalytic coating on face gasket

FIG. 4: Enlarged view of the interior surface of the lens and face gasket.
86. Photocatalytic particles
87. Face gasket electret substrate
88. Hydrophobic particles
89. Lens electret substrate
90. Hydrophobic particles
91. Photocatalytic particles coating, atoms, or zones
92. Hydrophobic particles coating, atoms, or zones
93. Photocatalytic particles
   Face gasket electret substrate
   Electrode
   Voltage source
   Electrode
   Voltage source
   Electrode

FIG. 5: Enlarged cross-sectional view of a coated fiber structure of the photocatalyst, electret, and hydrophobic areas.
70. Fiber substrate
71. Air
72. Hydrophobic coating
73. Photocatalytic hydrophilic coating
74. Electret coating
75. Particle attracted to the electret
76. Particle attracted and held by the electret
77. A water droplet
78. A particle in a beaded water droplet on the hydrophobic surface
79. A water droplet moving along the water adhesion gradient
80. A particle contained in the water droplet
81. A particle in a water droplet on the photocatalytic surface
82. A water droplet with a low contact angle on the photocatalytic surface
83. A particle

FIG. 6: Exploded cross-sectional view of an air and deodorization filtration system using an artificial light source, and a membrane water vapor delivery system.
120. The light reflector
121. The outgoing air flow
122. The outer photocatalytic coating fibers of cloth or on open cell foam
123. The electrostatic layer in the fiber cloth
124. The hydrophobic layer in the cloth porous surface, or film membrane
125. A water vapor permeable membrane
   The water reservoir tank
   Water vapor diffusion
128. Water in the tank
129. Captured particles on the electret surfaces
130. Particles on the photocatalytic surface
131. Blue light photons
132. Incoming air flow with particle and odors
133. Blue light source

FIG. 7: Clothing apparel on a human showing the usage areas for a photocatalytic, electret, hydrophobic fabric, or structure.
140. Hood outer shell
141. Face breathing filter
142. Arm pit vent area
143. Outer fabric arm sleeves
144. Bandage on arm
145. Gloves outer shell
146. Torso outer shell fabric
147. Pants outer shell fabric
148. Boot tops and sides

FIG. 8: An adhesive bandage using a photocatalytic, electret, hydrophobic fabric, or structure.
160. Adhesive coating
161. Hydrophobic coated fibers
162. Hydrophobic layer
163. Electret layer
164. Photocatalysts layer

While the invention has been described with reference to specific embodiments, modifications and variations of the invention may be constructed without departing from the scope of the invention, which is defined in the following claims.

1. A gas permeable apparatus comprising a structure including a plurality of surfaces, at least one of the surfaces comprising photocatalysts, at least another of the surfaces comprising electrets, at least one light source for exposing the at least one of the surfaces comprising the photocatalyst to light photons sufficient to activate the photocatalyst, the structure allowing for filtering particulates, wicking liquids, disinfecting, and deodorizing the surfaces.

2. The apparatus of claim 1, wherein the structure is a contiguous structure in contact with a gas comprising the photocatalysts, surface free energy gradients, and the electrets for filtering filter particulates, wicking liquids, disinfecting, and deodorizing on exposure to the light photons.

3. The apparatus of claim 1, wherein the wicking liquids comprise water or moisture.

4. The apparatus of claim 1, further comprising water on the photocatalyst.

5. The apparatus of claim 4, wherein the photocatalyst exposed to the light photons is activated in the presence of the water.

6. The apparatus of claim 1, further comprising different properties on different areas of the surfaces disposed spatially separated but in close proximity.

7. The apparatus of claim 6, further comprising a water adhesion gradient across the surface of the structure formed by the different areas having the different properties.

8. The apparatus of claim 7, wherein the at least one of the surfaces comprising the photocatalysts is a hydrophilic region.

9. The apparatus of claim 8, wherein the at least other of the surfaces comprising the electrets is a hydrophobic region.

10. The apparatus of claim 9, wherein the hydrophilic region is in close proximity to the hydrophobic region.

11. The apparatus of claim 1, further comprising liquids for contacting and removing particulates.

12. The apparatus of claim 11, wherein the liquid is water for contacting and removing particulates attracted to the electrets.

13. The apparatus of claim 1, wherein the structure is an apparel to filter particulates, wick water, disinfect, and deodorize.

14. The apparatus of claim 1, wherein the structure is portions of an eyewear to filter, wick water, disinfect, and deodorize.

15. The apparatus of claim 1, wherein the structure is an air filter.

16. The apparatus of claim 15, wherein the air filter is. periodically washable with liquids.

17. The apparatus of claim 15, wherein the air filter is self-cleaning.

18. The apparatus of claim 16, wherein the liquids comprise are water bearing liquids.

19. The apparatus of claim 1, wherein at least one of the surfaces is porous.

20. The apparatus of claim 19, further comprising a vapor source of water adjacent to the porous surface.

21. The apparatus of claim 21, wherein the vapor source of water is from an animal adjacent to the porous surface.

22. The apparatus of claim 21, wherein the vapor source of water is a water absorbent or wicking material adjacent the porous surface.

23. The apparatus of claim 21, wherein the vapor source of water is a moisture selectively permeable membrane adjacent the porous surface.

24. The apparatus of claim 1, further comprising a circuit and electrical coupling with the circuit, wherein the photocatalyst is electrically connected to the circuit.

25. The apparatus of claim 4, further comprising an electrolyte on one of the surfaces of the structure.

26. The apparatus of claim 25, wherein an electric current is generated and passes through the electrolyte by ion drag to move the water.

27. The apparatus of claim 25, wherein an electric current passes through water on the photocatalyst to move the water.

28. The apparatus of claim 26, further comprising electrodes, and wherein the electric current on the electrodes decompose chemicals, deodorize, and disinfect the structure.

29. The apparatus of claim 26, wherein the electric current heats, filters light, creates light, or reflects light.

30. The apparatus of claim 29, wherein the electric current provides an image display or creates an aesthetic appearance.

31. The apparatus of claim 26, wherein the electric current senses chemicals, humidity, condensation, and light.

32. The apparatus of claim 26, wherein the electric current provides sufficient energy to run electrical devices.

33. The apparatus of claim 1, wherein the structure is an apparel.

34. The apparatus of claim 33, wherein the apparel is selected from the group consisting of jackets, hats, bandages, pants, sweat bands, watches, prosthetics, ski masks, socks, boots, gloves, breathing filters, breathing apparatus, earmuffs, body armor, and combinations thereof.

35. The apparatus of claim 1, wherein the structure enables air filtration, deodorization, and disinfecting of machinery, buildings, and vehicles.

36. The apparatus of claim 1, wherein the structure enables air filtration, deodorization, and disinfecting of tents, window curtains, cat litter boxes, furniture, art objects, artificial plants, wall coverings, bulletin boards, and vehicle upholstery.

37. Eyewear apparatus comprising a structure including photocatalysts, water adhesion gradient surfaces at least one light source for exposing the photocatalysts to light photons sufficient to activate the photocatalysts, for wicking liquids, disinfecting, and deodorizing the eyewear.

38. The apparatus of claim 37, wherein the eyewear is protective goggles, and wherein the surfaces of the structure are air vents in the protective goggles.

39. The apparatus of claim 37, wherein the at least one light source is sunlight having light photons of sufficient energy to activate the photocatalysts.

40. The apparatus of claim 37, wherein the surfaces of the structure are lenses of goggles.

41. The apparatus of claim 40, wherein the surfaces of the structure are frames of goggles.

42. The apparatus of claim 37, wherein the surfaces of the structure are lenses and frames of the eyewear.

43. The apparatus of claim 37, wherein the water adhesion gradient surfaces further comprise hydrophobic and hydrophilic surfaces and wherein differences between the surfaces channel and move water from an interior of the eyewear to an exterior or a perimeter of the eyewear.

44. An air cleaner comprising a structure including a porous surface, a water source, a selectively permeable membrane to deliver water vapor adjacent to the porous surface, photocatalysts on the membrane, at least one light source to expose the photocatalysts to light photons sufficient to activate the photocatalyst for disinfecting and deodorizing the air cleaner.

45. The apparatus of claim 44, wherein the light source is blue light emitting diodes or fluorescent tubes.

46. The apparatus of claim 44, wherein the light source comprises water.

47. The apparatus of claim 44, further comprising an air flow selected from the group consisting of convection air flow, pump, fan, and combinations thereof.
